(19) United States
(12) Patent Application Publication
(10) Pub. No.: US 2026/0054531 A1
(43) Pub. Date: Feb. 26, 2026

(54) VALVE STEM ASSEMBLY

(71) Applicant: THE LEGION ENGINEERING CORPORATION, Changhua City (TW)

(72) Inventor: WAYNE-IAN MOORE, Worcestershire (GB)

(21) Appl. No.: 19/302,397

(22) Filed: Aug. 18, 2025

(30) Foreign Application Priority Data
Aug. 20, 2024 (TW) 113131288

(51) Int. Cl. B60C 29/00; F16K 24/00

(52) U.S. Cl. CPC B60C 29/005; F16K 24/00

(57) ABSTRACT

A valve stem assembly is provided, wherein the valve stem assembly includes: a valve stem including a shaft portion and a radial flange radially protruding from an outer circumferential surface of the shaft portion, the shaft portion including a threaded section; a blocking member movably sleeved on the shaft portion and blocked by the radial flange; and an elastic member sleeved on the shaft portion and blocked by the blocking member, configured to seal a valve installation hole of a rim.

### BACKGROUND OF THE INVENTION

Field of the Invention

The present invention relates to a valve stem assembly.

### Description of the Prior Art

Vehicles (such as bicycles, motorcycles, automobiles, etc.) are important transportation means, and tires are crucial components that enable vehicles to operate smoothly and efficiently. A tire valve is mounted to a rim and protrudes from the rim. Generally, a tire valve includes a valve stem assembly and a valve core installed in the valve stem assembly. The valve stem assembly is configured to be inserted in and fastened to the rim. The valve core is movably disposed relative to the valve stem assembly and operable to open or close a gas passage in the valve stem assembly for inflation or deflation.

Please refer to FIG. 1. A conventional valve stem 10a of a valve stem assembly is typically processed from a raw tubular material 200a having a large fixed outer diameter. The raw tubular material 200a retains the large outer diameter at one end portion, and the remainder is turned down to reduce its outer diameter to form a shaft portion 11a, so that a radial flange 12a is formed at the end portion, and a threaded section 111a is formed on the shaft portion 11a. The radial flange 12a is configured to directly block an elastic member which is sleeved on the shaft portion 11a and configured to seal a valve installation hole of a rim. A nut may be screwed to the threaded section 111a so that the elastic member and the nut are clamped and fastened to an annular wall of the rim. However, since the radial flange 12a is configured to directly block an elastic member, the outer diameter of the radial flange 12a should be considerably large, such that forming the shaft portion 11a requires a raw tubular material 200a with a larger outer diameter. Since volume is proportional to the square of the wall thickness of the raw tubular material 200a, a large amount of material must be removed. Therefore, the conventional valve stem 10a has high material cost, long processing time, and low production efficiency.

The present invention is, therefore, arisen to obviate or at least mitigate the above-mentioned disadvantages.

### SUMMARY OF THE INVENTION

The main object of the present invention is to provide a valve stem assembly that is easy to process, saves material, has low manufacturing cost, and includes components that may be flexibly and variously selected based on different requirements.

To achieve the above and other objects, a valve stem assembly is provided, wherein the valve stem assembly includes: a valve stem including a shaft portion and a radial flange radially protruding from an outer circumferential surface of the shaft portion, the shaft portion including a threaded section; a blocking member movably sleeved on the shaft portion and blocked by the radial flange; and an elastic member sleeved on the shaft portion and blocked by the blocking member, configured to seal a valve installation hole of a rim.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a radial side view of a conventional valve stem;

FIG. 2 is a radial side view of a valve stem according to an exemplary embodiment of the present invention;

FIG. 3 is a perspective view of a valve stem according to an exemplary embodiment of the present invention;

FIGS. 4 and 5 are partial enlarged views of a valve stem according to an exemplary embodiment of the present invention;

FIGS. 6 and 7 are axial side views of a valve stem according to an exemplary embodiment of the present invention;

FIG. 8 is a perspective view of a valve stem assembly 1 according to an exemplary embodiment of the present invention;

FIG. 9 is an exploded view of FIG. 8;

FIG. 10 is a cross-sectional view of FIG. 8; and

FIG. 11 is a schematic application view of an exemplary embodiment of the present invention.

### DETAILED DESCRIPTION OF THE PREFERRED EMBODIMENTS

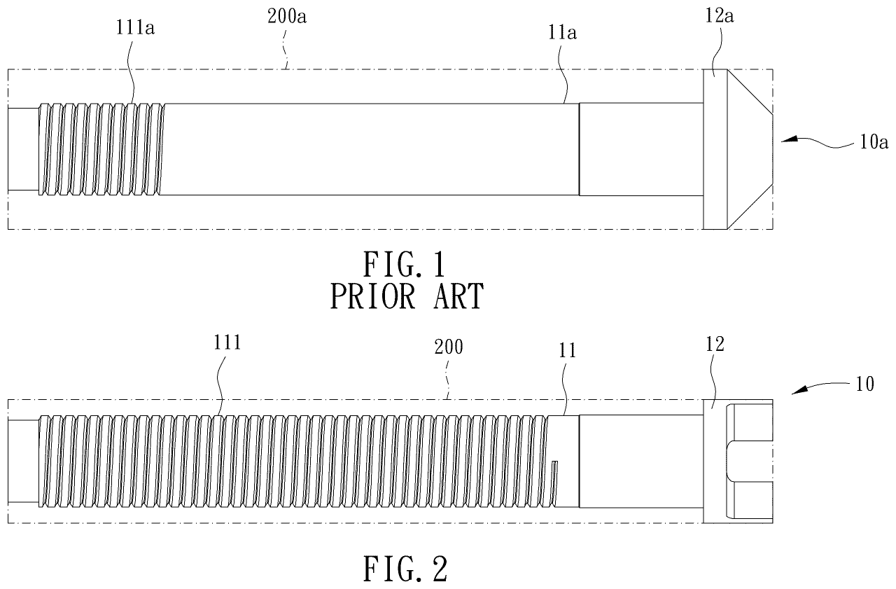

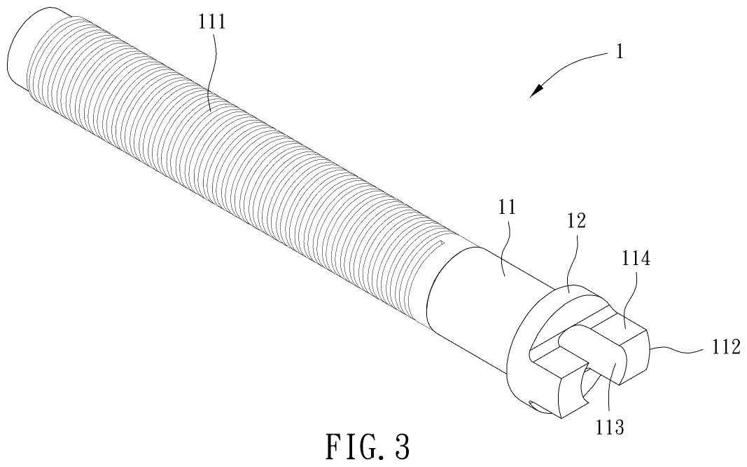

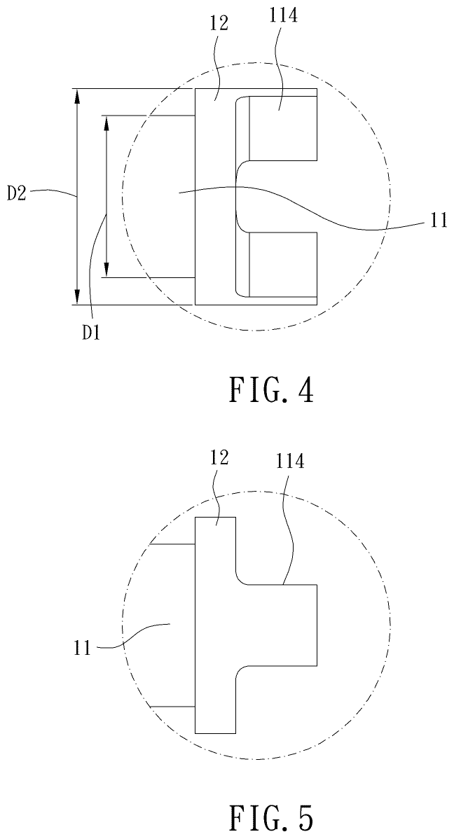

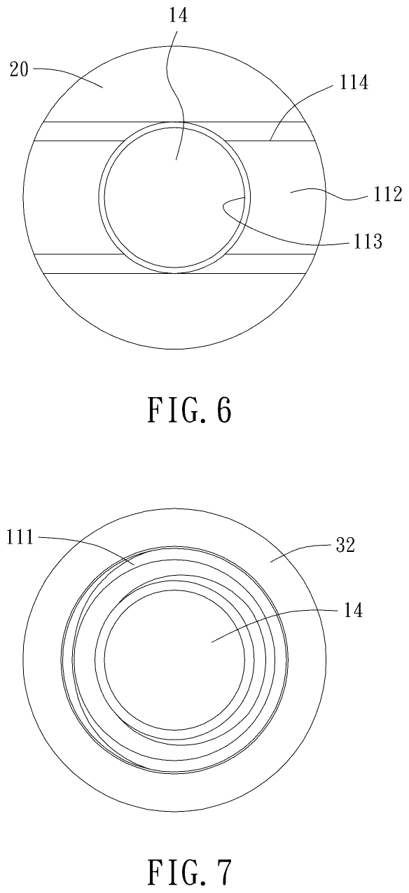

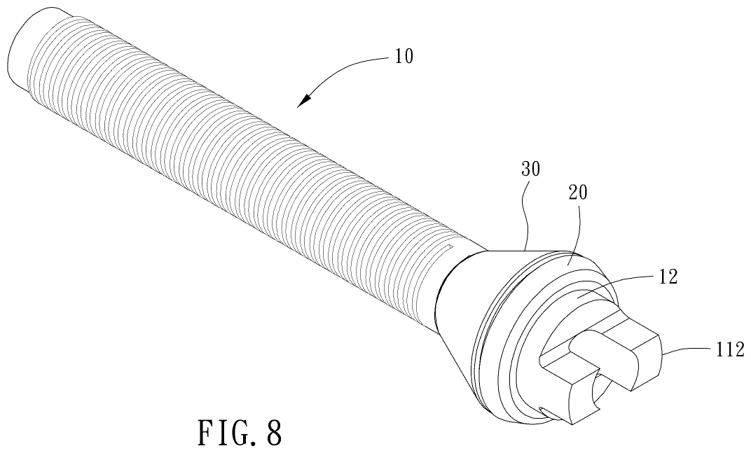

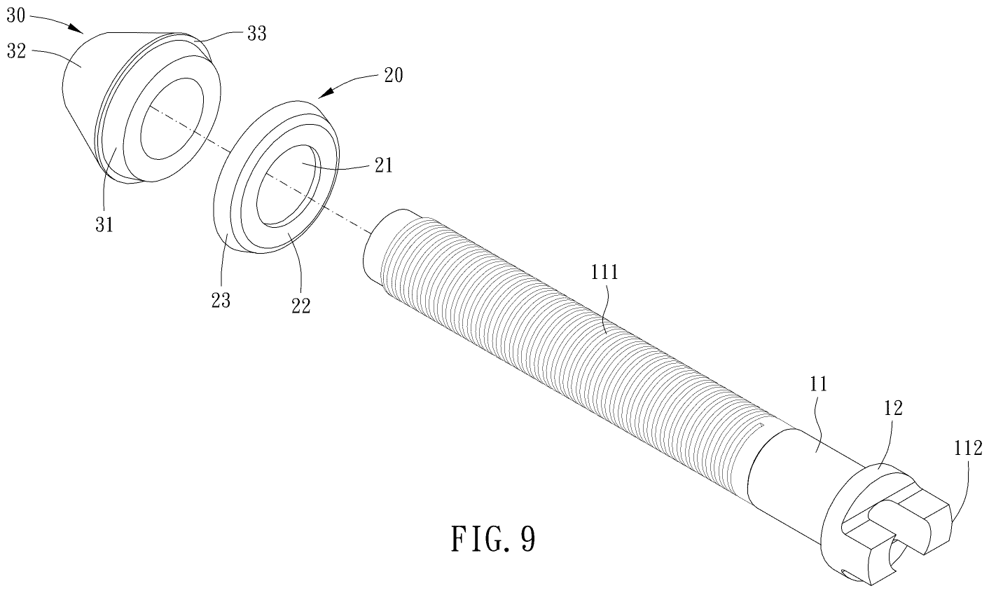

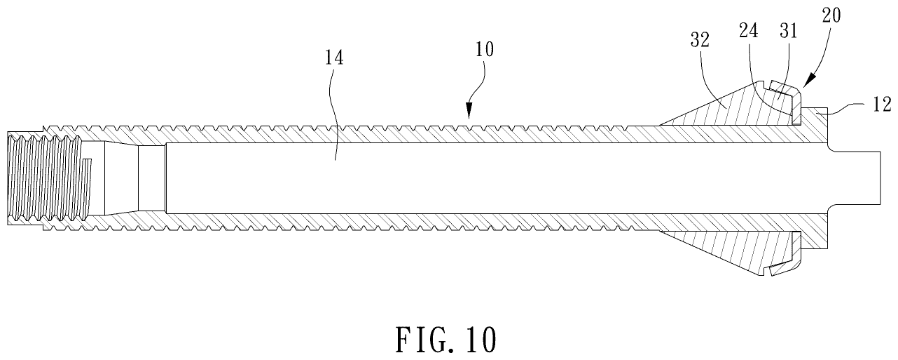

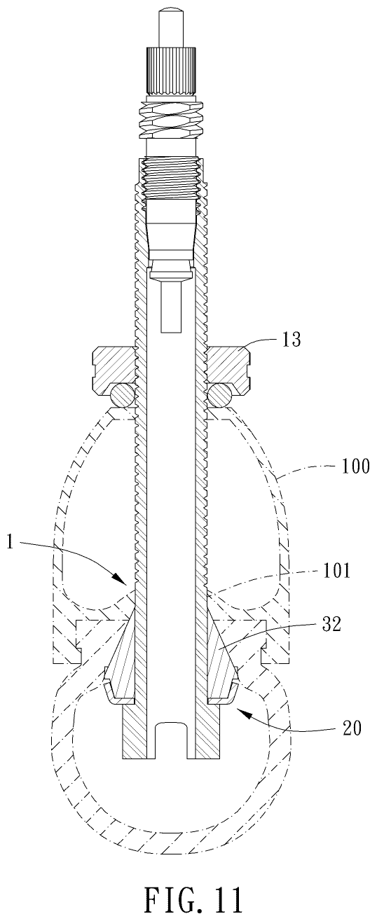

Please refer to FIGS. 2 to 11 for an exemplary embodiment of the present invention. A valve stem assembly 1 of the present invention includes a valve stem 10, a blocking member 20, and an elastic member 30.

The valve stem 10 includes a shaft portion 11 and a radial flange 12 radially protruding from an outer circumferential surface of the shaft portion 11. The shaft portion 11 includes a threaded section 111. The blocking member 20 is movably sleeved on the shaft portion 11 and is blocked by the radial flange 12. The elastic member 30 is sleeved on the shaft portion 11 and is blocked by the blocking member 20. The elastic member 30 is configured to seal a valve installation hole 101 of a rim 100. A nut 13 is screwed to the threaded section 111 so that the elastic member 30 and the nut 13 are clamped and fastened to an annular wall of the rim 100. An inner surface of an end of the shaft portion 11 may include internal threads, and a valve core assembly may be directly screwed from outside to the internal threads. Preferably, the threaded section 111 continuously extends at least seventy percent of a length of the shaft portion 11, making it suitable for rims of various types and sizes or for connecting different types of valve core assemblies at an end of the shaft portion 11. In a possible embodiment, a ratio of an outer diameter D1 of the shaft portion 11 to an outer diameter D2 of the radial flange 12 is not less than 0.6. For example, the ratio may be 0.625, 0.65, 0.675, 0.70, 0.725, 0.75, 0.80, 0.825, 0.85, or other values. The larger the ratio, the less material needs to be removed. As such, the valve stem 10 is easy to process, saves material, has low manufacturing cost, and the blocking member 20 and the elastic member 30 may be flexibly and variously selected based on different requirements.

Preferably, the shaft portion 11 and the radial flange 12 are integrally formed of one piece and have good structural strength. For example, the valve stem 10 is processed (e.g., turned) from a raw tubular material 200 having a fixed outer diameter, and an outer diameter of the radial flange 12 is equal to the fixed outer diameter of the raw tubular material 200. Specifically, the blocking member 20 includes a sleeving hole 21, and a diameter of the sleeving hole 21 is greater than an outer diameter of the threaded section 111. The valve stem 10 further includes an axial through hole 14. The shaft portion 11 further includes two drive projections 112. The two drive projections 112 axially project from an end surface of the radial flange 12 and are radially disposed opposite to each other at two sides of an opening of the axial through hole 14. Each of the two drive projections 112 includes an arcuate inner surface 113 and two flat surfaces 114 located at opposite sides of the arcuate inner surface 113. The arcuate inner surface 113 extends along a periphery of the opening of the axial through hole 14, and the two flat surfaces 114 are parallel to each other. The two drive projections 112 are configured for engagement of a driving tool for actuation.

The blocking member 20 may be made of metal or non-metal material. A material with higher hardness is preferably selected. In a possible embodiment, the blocking member 20 and the valve stem 10 are made of different materials. A hardness of the blocking member 20 is greater than a hardness of the valve stem 10. For example, the valve stem 10 is made of aluminum alloy, and the blocking member 20 is made of stainless steel.

Specifically, the blocking member 20 further includes an annular bottom wall 22 blocked against the radial flange 12 and a circumferential wall 23 connected to the annular bottom wall 22. The annular bottom wall 22 and the circumferential wall 23 form a receiving slot 24. The receiving slot 24 receives a portion of the elastic member 30, so that the elastic member 30 does not radially deform beyond the range of support of the blocking member 20 when subjected to force, thus providing good axial sealing effect. The annular bottom wall 22 and the circumferential wall 23 are integrally formed of one piece and have a same thickness. For example, the blocking member 20 is integrally bent and formed from a ring plate, allowing fast and simple manufacturing.

In this embodiment, the elastic member 30 includes an engaging protrusion 31 and a sealing end portion 32. An outer diameter of the engaging protrusion 31 is smaller than an outer diameter of the sealing end portion 32. The engaging protrusion 31 is received in the receiving slot 24. The sealing end portion 32 is configured to seal the valve installation hole 101 of the rim 100. Preferably, an outer diameter of the elastic member 30 is not greater than an outer diameter of the blocking member 20, so that the elastic member 30 does not radially exceed the support range of the blocking member 20 when deformed by force. An axial dimension of the engaging protrusion 31 is greater than a depth of the receiving slot 24, ensuring the engaging protrusion 31 reliably abuts the annular bottom wall 22.

Specifically, the engaging protrusion 31 tapers in a direction toward the annular bottom wall 22, facilitating fit and positioning between the engaging protrusion 31 and the blocking member 20. Preferably, a gap between a hole wall of the sleeving hole 21 and the shaft portion 11 is not greater than one-fifth of a distance between an inner edge and an outer edge of an end surface of the engaging protrusion 31. Alternatively, the gap is not greater than 1.2 mm. This stably holds the engaging protrusion 31 and significantly reduces material deformation flow of the engaging protrusion 31, thereby improving sealing stability and reliability of the elastic member 30. An extending direction of a portion of the circumferential wall 23 that is away from the annular bottom wall 22 may be perpendicular to the annular bottom wall 22, which can effectively block and limit the engaging protrusion 31. A gap between the circumferential wall 23 and the tapering engaging protrusion 31 may provide sufficient deformation allowance for the engaging protrusion 31. The sealing end portion 32 tapers in a direction away from the annular bottom wall 22, making it applicable for sealing valve installation holes of various diameters in different rims. The engaging protrusion 31 and the sealing end portion 32 form a shoulder 33 therebetween. The shoulder 33 axially faces an end surface of the circumferential wall 23, effectively limiting axial deformation of the elastic member 30 and confining the elastic member 30 within the receiving slot 24.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A valve stem assembly including:
a valve stem including a shaft portion and a radial flange radially protruding from an outer circumferential surface of the shaft portion, the shaft portion including a threaded section;
a blocking member movably sleeved on the shaft portion and blocked by the radial flange; and
an elastic member sleeved on the shaft portion and blocked by the blocking member, configured to seal a valve installation hole of a rim.

2. The valve stem assembly of claim 1, wherein the shaft portion and the radial flange are integrally formed of one piece.

3. The valve stem assembly of claim 2, wherein the valve stem is processed from a raw tubular material having a fixed outer diameter, and an outer diameter of the radial flange is equal to the fixed outer diameter of the raw tubular material.

4. The valve stem assembly of claim 1, wherein the blocking member includes a sleeving hole, and a diameter of the sleeving hole is greater than an outer diameter of the threaded section.

5. The valve stem assembly of claim 1, wherein a hardness of the blocking member is greater than a hardness of the valve stem.

6. The valve stem assembly of claim 1, wherein the blocking member includes an annular bottom wall blocked against the radial flange and a circumferential wall connected to the annular bottom wall, the annular bottom wall and the circumferential wall form a receiving slot, and the receiving slot receives a portion of the elastic member.

7. The valve stem assembly of claim 6, wherein the elastic member includes an engaging protrusion and a sealing end portion, an outer diameter of the engaging protrusion is smaller than an outer diameter of the sealing end portion, the engaging protrusion is received in the receiving slot, and the sealing end portion is configured to seal the valve installation hole of the rim.

8. The valve stem assembly of claim 1, wherein an outer diameter of the elastic member is not greater than an outer diameter of the blocking member.

9. The valve stem assembly of claim 7, wherein the shaft portion and the radial flange are integrally formed of one piece; the valve stem is processed from a raw tubular material having a fixed outer diameter, and an outer diameter of the radial flange is equal to the fixed outer diameter of the raw tubular material; the threaded section continuously extends at least seventy percent of a length of the shaft portion; the valve stem further includes an axial through hole; the shaft portion further includes two drive projections, the two drive projections axially project from an end surface of the radial flange and are radially disposed opposite to each other at two sides of an opening of the axial through hole, each of the two drive projections includes an arcuate inner surface and two flat surfaces located at opposite sides of the arcuate inner surface, the arcuate inner surface extends along a periphery of the opening, and the two flat surfaces are parallel to each other; the blocking member includes a sleeving hole, and a diameter of the sleeving hole is greater than an outer diameter of the threaded section; the blocking member and the valve stem are made of different materials, a hardness of the blocking member is greater than a hardness of the valve stem, the valve stem is made of aluminum alloy, and the blocking member is made of stainless steel; the annular bottom wall and the circumferential wall are integrally formed of one piece and have a same thickness; an axial dimension of the engaging protrusion is greater than a depth of the receiving slot; the engaging protrusion tapers in a direction toward the annular bottom wall, and the sealing end portion tapers in a direction away from the annular bottom wall; the engaging protrusion and the sealing end portion form a shoulder therebetween, and the shoulder axially faces an end surface of the circumferential wall; a gap between a hole wall of the sleeving hole and the shaft portion is not greater than one-fifth of a distance between an inner edge and an outer edge of an end surface of the engaging protrusion.

10. The valve stem assembly of claim 1, wherein a ratio of an outer diameter of the shaft portion to an outer diameter of the radial flange is not less than 0.6.
